(19) United States
(12) Patent Application Publication
(10) Pub. No.: US 2019/0253274 A1
(43) Pub. Date: Aug. 15, 2019

(54) NETWORK INTERCONNECTION SERVICE

(71) Applicant: Megaport (Services) Pty Ltd., Fortitude Valley (AU)

(72) Inventor: Brent Van Dussen, San Diego, CA (US)

(73) Assignee: Megaport (Services) Pty Ltd., Fortitude Valley (AU)

(21) Appl. No.: 15/897,045

(22) Filed: Feb. 14, 2018

(51) Int. Cl. H04L 12/46; H04L 29/06; H04L 29/12; H04L 12/24

(52) U.S. Cl. CPC H04L 12/4633; H04L 12/4641; H04L 41/0803; H04L 63/029; H04L 61/25; H04L 63/0272

(57) ABSTRACT

Large networks, such as those operated by businesses, educational institutions, governmental bodies, and the like, can utilize an interconnection service provider network to share data and resources between and among multiple computing service provider networks. An interconnection service provider network provider (or the network operator) may monitor performance and other metrics associated with resources provisioned in a first computing service provider network. Upon a determination that it would be more advantageous to utilize the resources of a second computing service provider network, the interconnection service provider network (or the network operator) can migrate data and other resources from the first computing service provider network to the second computing service provider network.

### TECHNICAL FIELD

The present technology pertains to computer networking, and more specifically to providing a network with optimized interconnectivity to other networks.

### BACKGROUND

Enterprises and other entities are increasingly looking toward hybrid cloud computing architectures for various technology needs. These enterprises and other entities may use a mix of “private” or on-premise processing, storage, network, and other computing resources and “public” or off-premise resources provisioned by third party computing service providers. In some cases, companies can configure their own data centers to interoperate with data centers managed by the third parties. For example, organizations may supplement their own technology resources with those offered by third party computing service providers to support peak capacity for the organizations' services without the substantial capital investment that would otherwise be necessary using a wholly private computing infrastructure. Alternatively or in addition, businesses can improve their services in different geographical regions by leveraging computing resources of service providers that are located more closely to foreign customers or establishing direct connections with those foreign customer's networks. Another important use case of hybrid cloud computing architectures is business continuity and disaster recovery. For example, a company can provide its services via its own network. At the same time, the company can replicate its technology within a particular service provider's computing infrastructure. When malicious actors compromise a company's data center(s) or when the company's data center(s) are otherwise unavailable, the company can continue to provide its services via the replicated technology located in the service provider's computing infrastructure. Organizations may also use computing service providers' infrastructure as development and/or testing environments before establishing a production environment within the organizations' own private network.

Although hybrid cloud computing architectures can offer enterprises numerous benefits, a concern that can dissuade these enterprises from adopting such architectures is vendor “lock-in.” Lock-in can occur when the cost of remaining with an incumbent service provider outweighs the benefits of switching to a new provider despite the superior cost-savings, service, and/or performance provided by the new provider. For example, to transfer an enterprise's data from one service provider to another service provider, it may be necessary to transfer the data back to the enterprise's data center and then migrate it to the new service provider. In addition, the data may require pre-processing from a format compatible with the incumbent provider's network to a format compatible with the new provider's network. A company may forego the benefits attainable from the new service provider because of the time, cost, and burden involved with migration.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1A and FIG. 1B illustrate examples of conventional hybrid cloud computing networks;

FIG. 2A, FIG. 2B, and FIG. 2C illustrate examples of services provided by an interconnection service provider network in accordance with some embodiments;

FIG. 3 illustrates an example of a hybrid cloud computing network in accordance with an embodiment;

FIG. 4A and FIG. 4B illustrate examples of a hybrid cloud computing network in accordance with some embodiments;

FIG. 5 illustrates an example of a network controller in accordance with an embodiment;

FIG. 6 illustrates an example process for monitoring customer network traffic in accordance with an embodiment;

FIG. 7 illustrates an example process for optimizing a network's interconnectivity with other networks in accordance with an embodiment;

FIG. 8A and FIG. 8B illustrate examples of computing systems in accordance with some embodiments; and

FIG. 9 illustrates an example computing environment in accordance with an embodiment.

### DETAILED DESCRIPTION

The National Institute of Standards and Technology (NIST) defines cloud computing as a model for enabling ubiquitous, convenient, on-demand access to a shared pool of configurable computing resources (e.g., networks, servers, storage, applications, and other computing services) that can be rapidly provisioned and released with minimal management effort or service provider interaction. NIST characterizes cloud computing as comprising five essential qualities—on-demand self-service, broad network access, resource pooling, rapid elasticity, and measured service. On-demand self-service refers to the capability of a customer to unilaterally provision computing resources, such as server time and network storage, as needed automatically without requiring human interaction with each service provider. Broad network access refers to providing computing resources over the network and giving access through standard mechanisms that promote use by heterogeneous thin or thick client platforms (e.g., mobile phones, tablets, laptops, and workstations).

Resource pooling refers to pooling computing resources to serve multiple customers using a multi-tenant model, with different physical and virtual resources dynamically assigned and reassigned according to customer demand. The computing resources are location-independent in that the customer generally has no control or knowledge over the exact location of the provided resources but may be able to specify location at a higher level of abstraction (e.g., country, state, or datacenter). The computing resources can include processing, memory, storage, and networking resources. For example, computing resources may represent physical compute/processing devices (servers, CPUs, GPUs, random access memory, caches, etc.), storage devices (e.g., network attached storages, storage area network devices, hard disk drives, solid-state devices, etc.), and network devices (switches, routers, firewalls, deep packet inspectors, traffic monitors, load balancers, etc.). Computing resources may also represent combinations of lower-level resources or “off-the-shelf” applications, such as a content delivery network (CDN), a database, a virtual private network (VPN), a domain name system (DNS), load balancing, identification and authentication (e.g., Active Directory from Microsoft, key management), analytics, a workflow manager, media streaming, payment, email, simple notification service (SNS), text messaging or short message service (SMS), search, a source control system (SCCS) or version control system (VCS), or monitoring services, among others.

Rapid elasticity refers to provisioning and releasing computing resources elastically (automatically in some cases) to scale rapidly outward and inward commensurate with demand. To the customer, the computing resources available for provisioning may appear to be unlimited and capable of appropriation in any quantity at any time. Measured service refers to automatic control and optimization of resource utilization by leveraging a metering capability at some level of abstraction suitable to the type of service (e.g., storage, processing, bandwidth, and active user accounts). A provider and a customer can monitor, control, and report resource utilization to provide transparency for both the provider and the customer.

Providers may offer their computing resources using various service models, such as software as a service (SaaS), platform as a service (PaaS), and infrastructure as a service (Iaas). In the SaaS model, a provider delivers to customers the provider's application(s) over a remote computing infrastructure. The application(s) may be accessible from a variety of client devices, such as through a web browser, a graphical user interface of a stand-alone application, or an application programming interface (API), among other interfaces known to one of ordinary skill. The customer typically does not manage or control the underlying computing infrastructure (i.e., network, servers, operating systems, storage, etc.) or individual application capabilities, with the possible exception of limited user-specific application configuration settings. In the PaaS model, a customer deploys customer-created (i.e., proprietary software) or acquired applications (e.g., open source and/or purchased software) created using programming languages, libraries, services, and tools supported by the provider. The customer generally does not manage or control the underlying computing infrastructure but may have control over the deployed applications. In the IaaS model, customers can provision processing, memory, storage, network resources, and other computing resources from a provider's computing infrastructure. The customer may deploy and run arbitrary software, including operating systems and server applications. The customer typically has control over operating systems, storage, and deploying applications but may not have control over the underlying hardware with the possible exception of certain networking components (e.g., firewalls, deep packet inspectors, traffic monitors, load balancers, etc.).

Customers can utilize computing service providers' offerings using various deployment models, such as private clouds, computing service provider networks, and hybrid clouds. In a private cloud, a single organization comprising multiple in-house “customers” (e.g., business units, departments, divisions, etc. of the same enterprise) may own, manage, and/or operate the computing infrastructure for exclusive use by the organizations' customers. The computing infrastructure may exist on-premises or off-premises. In a computing service provider network, a provider provisions computing resources for open use by the general public. A business, academic, or government organization can own, manage, and operate the computing infrastructure, which typically exists on the provider's premises. In a hybrid cloud, the computing infrastructure is a composition of two or more distinct computing infrastructures (private or public) that remain unique entities but may be bound together by standardized or proprietary technology that enables data and application portability (e.g., bursting for load balancing between networks). Businesses may leverage technology resources provisioned by computing service providers for various reasons, such as to dynamically expand capacity to support peak workloads; extend offerings to geographic locations closer to customers located abroad; develop, test, and otherwise experiment within multiple, heterogeneous computing environments; and implement off-premise business continuity and disaster recovery solutions, among other possibilities. Another benefit of the advent of cloud computing is the availability of multiple computing service providers. For example, a first computing service provider may offer better performance and/or prices during one part of a day and a different computing service provider may offer better performance and/or prices during a different part of the day. A company may want to take advantage of these differences between and/or among providers, such as by utilizing the first computing service provider during the first part of the day and then utilizing the second computing service provider during the second part of the day.

As another example, a natural disaster, a critical “bug,” malicious network activity, or similar circumstances can interrupt service(s) provided by the company's own network or the company's service(s) provisioned within a particular computing service provider's infrastructure. To continue providing its services, the company may relocate its service(s) to a different computing service provider's network. Relatedly, the company may want to enhance security or ensure continuity by being able to rapidly switch computing service providers. Alternatively or in addition, the company may want to replicate its application(s) across multiple computing service providers' networks in the event of a disaster occurring on its own premises or the premises of a primary computing service provider.

Although the availability of multiple computing service providers can provide enterprises numerous benefits, many enterprises may not be able to take advantage of these benefits. For example, once an enterprise has established its application(s) within a particular service provider's computing infrastructure, it can be technically difficult and/or cost-prohibitive to migrate its application(s) to a different provider's infrastructure. One potential solution for enabling interconnectivity is for the enterprise to build out a first network to the first computing service provider and a second network to the second computing service provider and migrate workloads and/or data from the first service provider to the second service provider and vice versa at specified times.

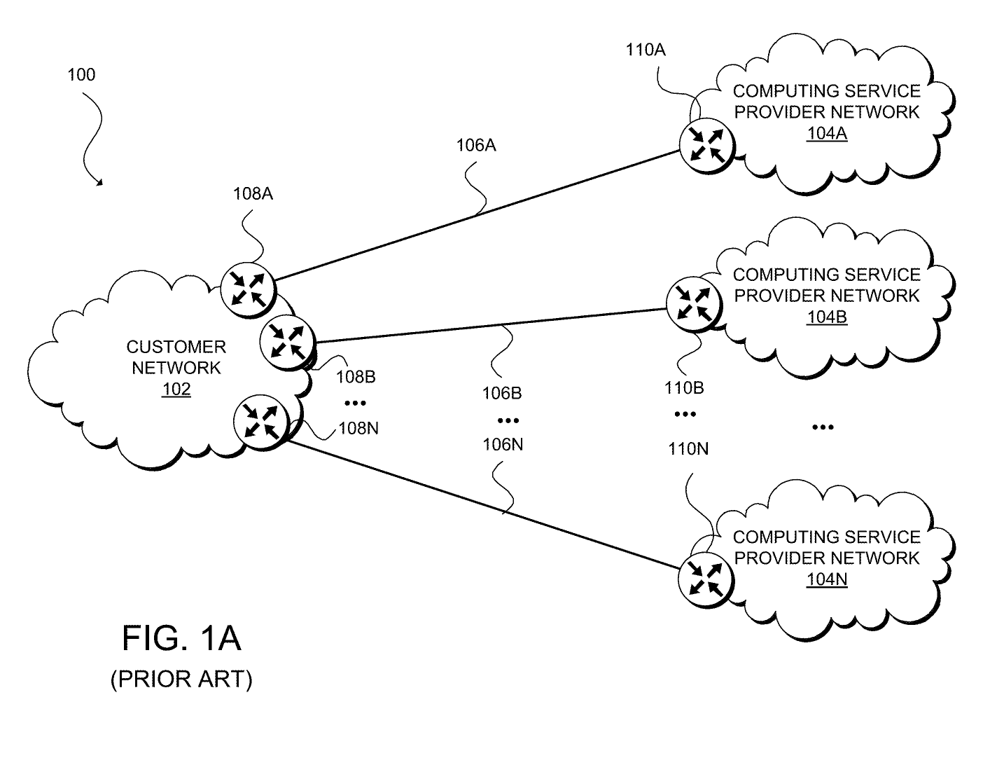

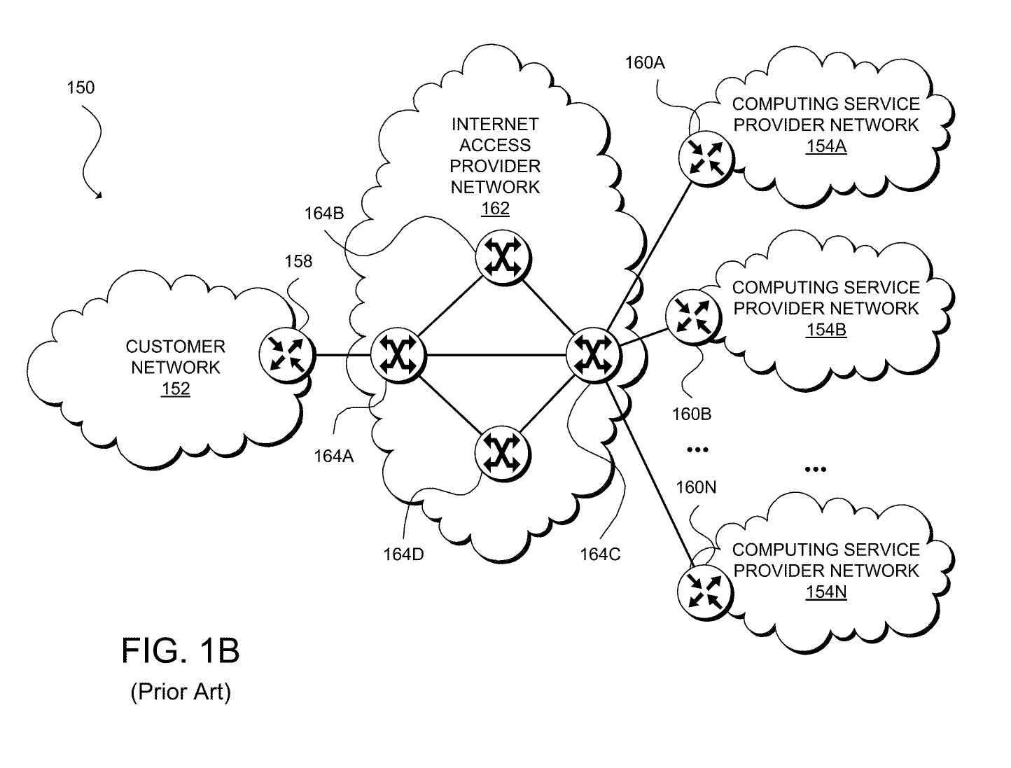

FIG. 1A illustrates a high-level view of a conventional hybrid cloud computing network 100 using such an approach. Hybrid cloud computing network 100 includes multiple networks, such as customer network 102 (e.g., an enterprise data center) connected to computing service provider networks 104A, 104B, . . . , and 104N (collectively, “104”) In various embodiments, computing service providers 104 can include Internet access providers (sometimes referred to as carrier networks or tier 1 networks), interconnection service providers (sometimes referred to as transit service providers), mailbox providers, hosting service providers, SaaS providers, PaaS providers, IaaS providers, etc.). In this example, customer network 102 connects to computing service provider networks 104A, 104B, . . . , 104N via communication links 106A, 106B, . . . , and 106N, respectively (collectively, “106”). In particular, network devices (e.g., routers, switches, etc.) 108A, 108B, . . . , and 108N (collectively, “108”) within customer network 102 connect to network devices 110A, 110B, . . . , and 110N (collectively, “110”) within computing service provider networks 104, respectively, via communication links 106.

Customer network 102 is an example of a local area network (LAN). LANs typically connect nodes (e.g., servers, client computing devices, routers, switches, etc.) over dedicated private communications links located in the same general physical location, such as a building or campus. A wide area network (WAN), such as network 100, on the other hand, typically connects geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

There are various disadvantages with implementing an architecture such as that illustrated in FIG. 1A. First and foremost, hybrid cloud computing network 100 negates one of the key benefits of cloud computing because it may require the company to purchase and maintain the physical hardware and fiber cables (or other connection medium) connecting the company's network to multiple computing service provider networks. The company must purchase, install, and maintain network devices, fiber or other physical linking medium, network appliances (e.g., firewalls, load balancers, traffic monitors, deep packet inspectors, etc.), and other network components to maintain connectivity between customer network 102 and each computing service provider network 104. Further, due to the expense of building out a network, the company may limit itself to connecting to a small number of computing service providers and fail to acquire the benefits arising from the availability of a wider array of service providers. In addition, for business, regulatory, and/or technical reasons, not all computing service providers may be capable of providing a network interface at a scale that can support a substantial number of enterprise-level private network connections or a particular computing service provider may prefer to operate a network interface of a limited scale. Thus, implementing a network architecture similar to network 100 may not be possible or may fare poorly in many situations.

Another potential solution for external network interconnectivity is for a company to transfer its workloads and/or data from a first computing service provider network to the company's network over the Internet, and then transfer that data to a second computing service provider network. In this scenario, the company can acquire the services of an Internet Access Provider (IAP) for transferring workloads and/or data from the first service provider network to the company's network, and utilize the services of the same IAP or a different IAP for transferring the workloads and/or data from the company's network to the second computing service provider network.

FIG. 1B illustrates a high-level view of a conventional hybrid cloud computing network 150 that adopts this implementation. Hybrid cloud computing network 150 is similar to hybrid cloud computing network 100 in many respects. For example, hybrid cloud computing network 150 comprises multiple networks, such as customer network 152 and computing service provider networks 154A, 154B, . . . , and 154N (collectively, “154”). However, instead of direct communication links between a private network and multiple computing service provider networks, customer network 152 connects to computing service provider networks 154 over the Internet (e.g., using services provided by IAP network 162). The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. An intermediate network node, such as a router, may further interconnect computer networks to extend the effective size of each network.

In hybrid cloud computing network 150, edge router 158 (sometimes referred to as a customer edge (CE) router or device) in customer network 152 connects to edge router 164A (sometimes referred to as a provider edge (PE) router or device) in IAP network 162. IAP network 162 may route traffic arriving to router 164A from router 158 to other routers, such as routers 164B, 164C, and 164D (sometimes referred to as provider (P) routers or devices). In this example, router 164C can also operate as a provider edge router to distribute traffic destined for computing service provider networks 154A, 154B, . . . , 154N (collectively, “154”) to customer edge routers 160A, 160B, . . . , 160N, respectively. IAP network 162 directly connects to customer network 152 and computing service provider networks 154 in FIG. 1B for purposes of simplicity and conciseness; however, unless IAP network 162, customer network 152, and computing service provider networks 154 are part of a same tier 1 network, IAP network 162 must rely on higher-tier networks and/or peer networks for connecting private customer network 152 to computing service provider networks 154.

For example, a tier 1 network is a network that can reach every other network on the Internet independently (i.e., does not rely on other networks for IP transit or have a settlement relationship with other networks). A tier 2 network peers with some networks but depends on other networks for IP transit or has a settlement relationship with another network (i.e., networks must compensate one another based on disparities in the amount of traffic exchanged between the networks) to reach at least a portion of the Internet. A tier 3 network is entirely dependent on other networks to participate in the Internet. Thus, a customer of a tier 1 network expects the traffic the customer forwards to the tier 1 network to be able reach any other endpoint on the Internet. However, the traffic may take a circuitous route if the other endpoint does not directly connect to the tier 1 network and the traffic must instead pass through a peer of the tier 1 network. A customer of a tier 2 network can expect the traffic the customer forwards to the tier 2 network to be able reach a portion of the Internet. The customer can make other arrangements for its traffic intended for other parts of the Internet, or more typically, the tier 2 network routes the traffic for the customer through a tier 1 network (who may forward to a peer tier 1 network) or another tier 2 network (who may rely on transit from a tier 1 network or peering with another tier 2 network). The customer of the tier 3 network expects the customer's traffic to traverse several different providers (i.e., tier 1 and tier 2 networks) since the tier 3 network must use transit services provided by tier 2 networks (and sometimes tier 1 networks).

Using the approach of FIG. 1B for external network interconnectivity, a company may be able to connect to all or a greater number of computing service provider networks than conventional hybrid cloud computing network 100 of FIG. 1A. The company is also generally not responsible for building out and maintaining network connectivity between customer network 152 and provider networks 154 (with possibly the exception of edge routers to IAP network 162). However, in hybrid cloud computing network 150, the company is dependent on the public Internet for transferring its workloads and data, which is often less secure than communicating over private network connections. For example, for an attacker to steal a copy of data frames passing over the private network connection (e.g., communication link 106 of FIG. 1A), the attacker would have to physically tap into the physical medium of the private network connection (e.g., fiber or cable). With communications over the Internet, an attacker can find less-intrusive ways to steal customer data. In addition, the provider of IAP network 162 typically cannot guarantee its customers a specified bandwidth for transferring their workloads and data such that migration from a first computing service provider network (e.g., computing service provider network 154A) to a second computing service provider network (e.g., computing service provider network 154B) may introduce an unacceptable amount of latency. Connectivity over the Internet also likely increases the number of hops for packets sent between customer network 152 and computing service provider networks 154, thereby further increasing latency.

Systems and methods in accordance with various embodiments of the present technology may overcome one or more of the above-referenced and other deficiencies in conventional approaches for providing external network interconnectivity. In particular, various embodiments can utilize an interconnection service provider network to share a customer's data and resources between multiple computing service provider networks. For example, a provider of the interconnection service provider network or the customer itself may monitor performance and other metrics associated with resources of a first computing service provider network. Upon a determination that it would be more advantageous to utilize the resources of a second computing service provider network, the interconnection service provider or the customer itself can migrate the customer's data and other resources from the first computing service provider network to the second computing service provider network. In some embodiments, the interconnection service provider network directly connects to the customer's private network and multiple computing service provider networks. The interconnection service provider network can operate as an extension of the customer network for purposes of transferring the customer's data between the first computing service provider network and the second computing service provider network. In this manner, the customer can transfer data between the first computing service provider network and the second computing service provider network but avoid the latency associated with conventional hybrid cloud computing networks. Further, the company can leverage the guaranteed bandwidth and secure connectivity provided by the interconnection service provider network but abrogate the responsibilities of building and maintaining network connectivity to the computing service provider networks to the interconnection service provider. Additionally, the company can avail itself of the services of a greater number of computing service providers than may be possible with conventional hybrid cloud computing networks. Embodiments described and suggested below may offer other functions and advantages appreciable to a skilled artisan.

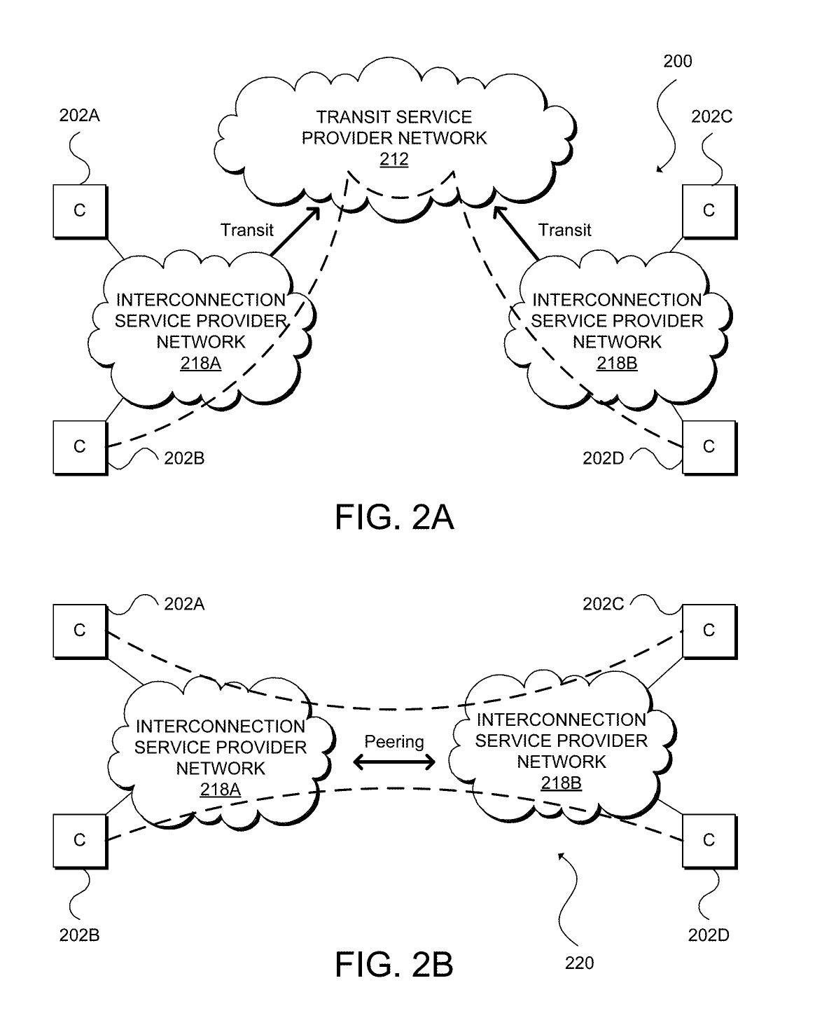

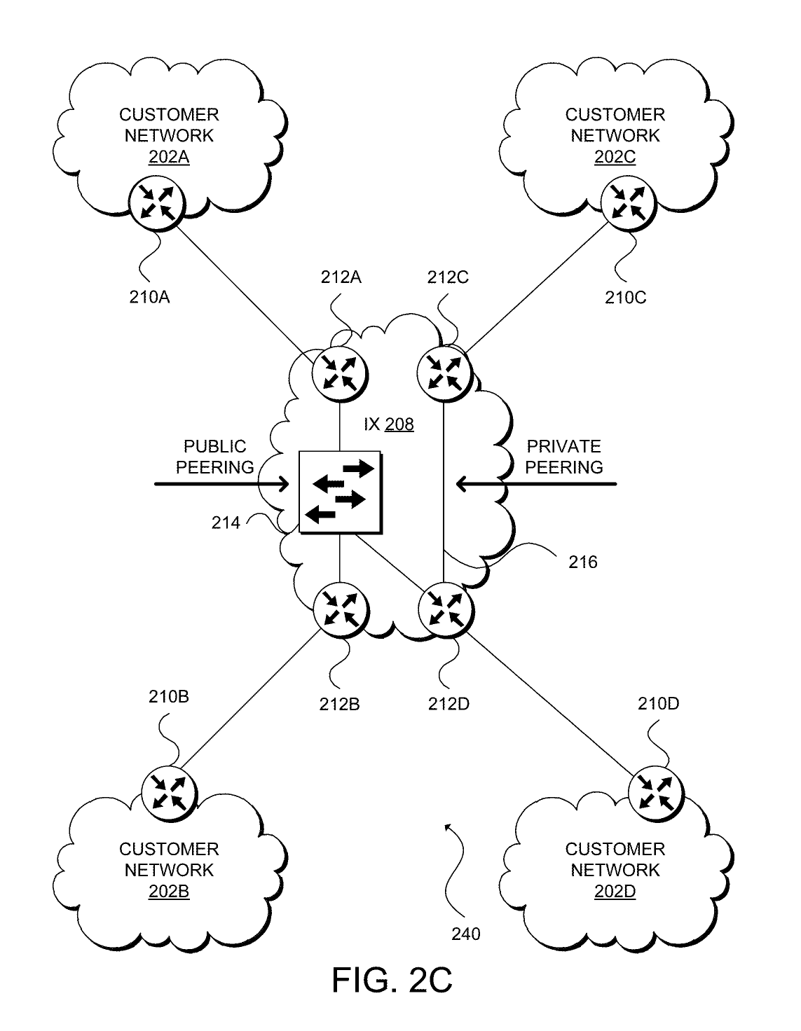

FIG. 2A, FIG. 2B, and FIG. 2C illustrate examples of network configurations for providing services offered by an interconnection service provider network. Businesses that are customers of computing service providers typically connect to the providers and end users (i.e., the businesses' customers) over the public Internet. However, communications over the Internet may not satisfy the businesses' and/or end users' performance and/or security requirements. Alternatively or in addition, other communication channels may be more cost-effective for connecting businesses to computing service provider networks and/or end users. One approach for providing external network interconnectivity to a business is to use the services of an interconnection service provider. An example of an interconnection service provider is Megaport® Limited of Fortitude Valley, Queensland Australia.

Networks typically use Border Gateway Protocol (BGP) to route external traffic. For example, an individual network (sometimes referred to as an autonomous system (AS)) on the Internet can have a globally unique autonomous system number (ASN) allocated by a Regional Internet Registry (RIR). The RIR can also handle allocation of IP addresses to networks. An AS can establish BGP peering sessions with other autonomous systems to exchange routing information. A BGP peering session is a TCP session established between two routers in respective autonomous systems. A BGP peering session can occur across a link, such as a 10 Gigabit Ethernet (10GE) or 100GE interface between the routers. The routing information can include an IP address prefix and subnet mask that translates which IP addresses are associated with which autonomous system number (i.e., an AS origin). Routing information can propagate across these autonomous systems based on policies that an individual network may define.

Autonomous systems can have certain relationships among one another, such as transit relationships or peering relationships. Interconnection service providers can support these relationships as services or offerings. For instance, FIG. 2A illustrates an example network configuration 200 showing transit relationships between transit service provider network 212 and interconnection service provider networks 218A and 218B (collectively, “218”), transit relationships between interconnection service provider network 218A and customer networks 202A and 202B, and transit relationships between interconnection service provider network 218B and customer networks 202C and 202D. Customer networks 202A, 202B, 202C, and 202D (collectively, “202”) typically comprise a main local area network and multiple branch office networks. Interconnection service provider networks 218 directly connect to transit service provider networks 212 for access to other networks that transit service provider networks 212 can reach, and customer networks 202 directly connect to interconnection service provider networks 218 for interconnection to other endpoints and networks accessible by interconnection service provider networks 218.

In general, transit service providers (e.g., transit service provider network 212 vis-à-vis interconnection service provider networks 218 and interconnection service provider networks 218 vis-à-vis customer networks 212), receive traffic from their customers and forward that traffic onto its intended destination (or at least closer to its intended destination). The transit service providers can also propagate routing information of its consumers to other accessible networks. In this example, transit provider network 212 can be a tier 1 or tier 2 network, interconnection service provider networks 218 can be tier 2 networks, and customer networks 202 can be tier 3 networks.

Peering is a network relationship in which an autonomous system connects to another autonomous system to exchange traffic and routing information with each other and their respective customers. Peering can be private or public. FIG. 2B illustrates an example network configuration 220 showing a private peering relationship between interconnection service provider networks 218A and 218B in which the networks directly connect to one another to provide customer networks 202A and 202B with interconnectivity to customer networks 202C and 202D. In some embodiments, interconnection service provider networks can run a pair of fiber-optic cables (a transmitting link and a receiving link, forming a cross-connect) to one another's edge routers (not shown). In other embodiments, interconnection service provider networks 218 may run their equipment to a common location sometimes referred to as an Internet Exchange (IX), a carrier hotel, or a meet-up room.

FIG. 2C illustrates an example network configuration 240 including an IX 208 for interconnecting customer networks 202A, 202B, 202C, and 202D, each including edge routers 210A, 210B, 210C, and 210D, respectively, that connect to routers 212A, 212B, 212C, and 212D, respectively, of IX 208. In this example, IX 208 can support public peering between and among customer networks 202A, 202B, and 202D and private peering between customer networks 202C and 202D. IX 208 can include a shared switching fabric (e.g., Ethernet switch 214) to provide one-to-many connections between and among networks 202A, 202B, and 202D and cross-connect 216 to provide a one-to-one connection between customer networks 202C and 202D.

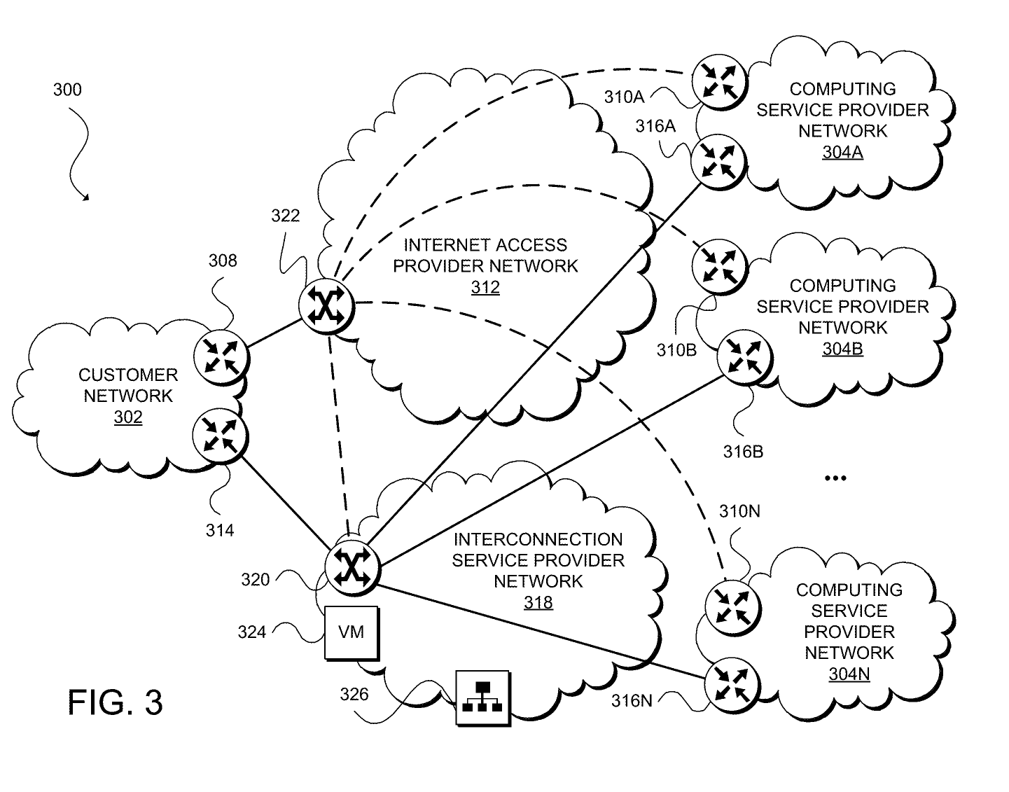

FIG. 3 illustrates an example of a hybrid cloud computing network 300 that integrates an interconnection service provider network for connectivity with external networks. Discussion of each of the components of FIG. 3 follows below; however, one skilled in art will understand that the system shown in FIG. 3 and any other system discussed herein is but one possible configuration and that other configurations with more or less components are also possible. Hybrid cloud computing network 300 includes customer network 302, computing service provider networks 304A, 304B, . . . , and 304N (collectively, “304”), Internet access provider network 312, and interconnection service provider network 318. In this example, customer network 302, computing service provider networks 304, IAP network 312, and interconnection service provider network 318 are IP networks. However, one of ordinary skill in the art will appreciate that other embodiments may include networks that implement any combination of networking protocols for enabling communications between the networks.

Customer network 302 includes two interfaces, a public interface associated with edge router 308 for connecting to computing service provider networks 304 via Internet access provider network 312, and a private interface associated with edge router 314 for connecting to computing service provider networks 304 via interconnection service provider network 318. Specifically, edge router 308 can operate as a CE router to connect to PE router(s) (not shown) associated with Internet access provider network 312 that ultimately connect to CE routers 310A, 310B, . . . , and 310N (collectively, “310”) associated with computing service provider networks 304A, 304B, . . . , and 304N, respectively. In this example, computing service provider networks 304A, 304B, . . . , and 304N also include edge routers 316A, 316B, . . . , and 316N, respectively, for establishing private interfaces that directly connect to edge router 320 in interconnection service provider network 318, and edge router 320 directly connects to the private interface of customer network 302 established by router 314 as well as to edge router 322 in Internet access provider network 312 for purposes discussed further below.

In this example, customer network 302 includes a pair of networking devices, edge routers 308 and 314, and each computing service provider network 304 includes a pair of networking devices, edge routers 310 and 316, for establishing a private interface and a public interface, respectively. However, other embodiments may utilize any number of routers for establishing any number of interfaces. Routers 308, 310, 314, 316, 320, and 322 may support a multitude of routing protocols and services, such as Open Shortest Path First (OSPF), Interior Gateway Routing Protocol (IGRP), Enhanced Interior Gateway Routing Protocol (EIGRP), Intermediate System to Intermediate System (IS-IS), Routing Information Protocol (RIP), Border Gateway Protocol (BGP), Virtual Private LAN Service/Virtual Leased Line (VPLS/VLL), or other suitable routing protocols or services. In addition or alternatively, routers 308, 310, 314, 316, and 320 may support various label protocols, such as Multiprotocol Label Switching (MPLS), Label Distribution Protocol (LDP), BGP, Resource Reservation Protocol (RSVP), Constraint-based Routing Label Distribution Protocol (CR-LDP), or other suitable label protocols.

Interconnection service provider network 318 includes network devices 320 and 322, VM 324, and network controller 326. Although this example shows interconnection service provider network 318 having a pair of networking devices, an interconnection service provider network in other embodiments may comprise any other number of networking devices, communication links, and other network components, including at least a direct link to a customer network (e.g., customer network 302) and direct links to multiple computing service provider networks (e.g., computing service provider networks 304). It is the dedicated connections between customer network 302 and interconnection service provider network 318 and between interconnection service provider network 318 and computing service provider networks 304 that allows for the guaranteed bandwidth, reduced latency, additional security, and other benefits provided by interconnection service provider network 318.

In some embodiments, interconnection service provider network 318 can provide customers with various network services, such as interconnectivity between multiple computing service provider networks, L2 point-to-point connections using Virtual Extensible LAN (VXLAN) or Virtual Leased Links (VLLs) between two customer facing ports (sometimes referred to as virtual cross connections or VXCs), and L2 point-to-multipoint connections using Ethernet Virtual Private Network (EVPN) or VPLS for direct peering or exchanging routing information and traffic via provider managed route servers (sometimes referred to as Internet Exchanges or IXs).

Interconnection service provider network 318 may provide a platform or application programming interface (API) for customers to make requests to interconnect their networks with computing service provider networks 304 or other networks via VXCs or IXs. In some embodiments, interconnection service provider network 318 may be operated by Megaport® (Services) Pty Limited of Fortitude Valley, Queensland, Australia. The Megaport® platform utilizes a representational state transfer (REST) architecture that exposes various “RESTful” endpoints or web services that are accessible via uniform resource identifiers (URIs). These web services can include authentication, obtaining information about available network resources, obtaining information about other networks, obtaining pricing information, migrating data and workloads from a first computing service provider network or other network to a second computing service provider network or other network, ordering VXCs or IXs, and obtaining invoices, among other services. Megaport® offers various graphical user interfaces (GUIs) that are built on top of the Megaport® API, such as a web portal that can be accessed by desktop and mobile web browsers, mobile applications or “apps” (e.g., Android, iOS, Windows Phone, Blackberry OS, etc.), and desktop applications (e.g., Windows, Mac OS X, Linux, UNIX, etc.).

In general, computing service provider networks 304 are computer networks for providing Internet-based computing in which computing resources may be dynamically provisioned and allocated to users on-demand, from a collection of resources available via the network. The computing resources can include any type of infrastructure resource, such as a computing, storage, and/or networking instance. For example, infrastructure resources may include compute/processing devices (e.g., servers, CPUs, GPUs, random access memory, caches, etc.), storage devices (e.g., network attached storages, storage area network devices, hard disk drives, solid-state devices, etc.), or network devices (e.g., routers, switches, firewalls, deep packet inspectors, traffic monitors, load balancers, etc.). The computing resources can also include a combination of infrastructure resources that provide users higher-level services or applications, such as a database service, software development platform, content delivery network, enterprise email system, collaboration tool, customer relationship management (CRM) software, etc.

Computing service provider networks 304 can represent separate networks, separate regions of a same computing service provider network (e.g., U.S. West and U.S. East), or separate zones of a same computing service provider network (e.g., U.S. West 1 (San Francisco) and U.S. West 2 (Seattle)). Examples of computing service provider networks include IaaS provider networks (e.g., Amazon Web Services (AWS) or Microsoft Azure); PaaS provider networks (e.g., Heroku, Google App Engine, or RedHat OpenShift); and SaaS provider networks, including accounting software service provider networks (e.g., Intuit QuickBooks or Freshbooks), CDN provider networks (e.g., Akamai or Limelight Networks), collaboration software service provider networks (e.g., Cisco WebEx or Slack), customer relationship management software provider networks (e.g., SalesForce or Zendesk), email service provider networks (Google Gmail or Yahoo Mail), security service provider networks (e.g., Radware or Arbor Networks), file sharing service provider networks (e.g., Dropbox and Box), office software provider networks (e.g., Microsoft Office 365 or Google Docs), project management software service provider networks (e.g., Trello), source code versioning control system software service provider networks (e.g., GitHub), among many others.

As discussed above with respect to hybrid cloud computing network 150 of FIG. 1B, an Internet access provider network actually comprises multiple networking devices and multiple networks but Internet access provider network 162 is shown as a single cloud in the example of FIG. 1 for purposes of simplicity and conciseness. Thus, it is almost always (if not always) the case that network traffic between a private network and a computing service provider network traversing an IAP network will take more hops than traffic between a private network and a computing service provider network traversing a interconnection service provider network.

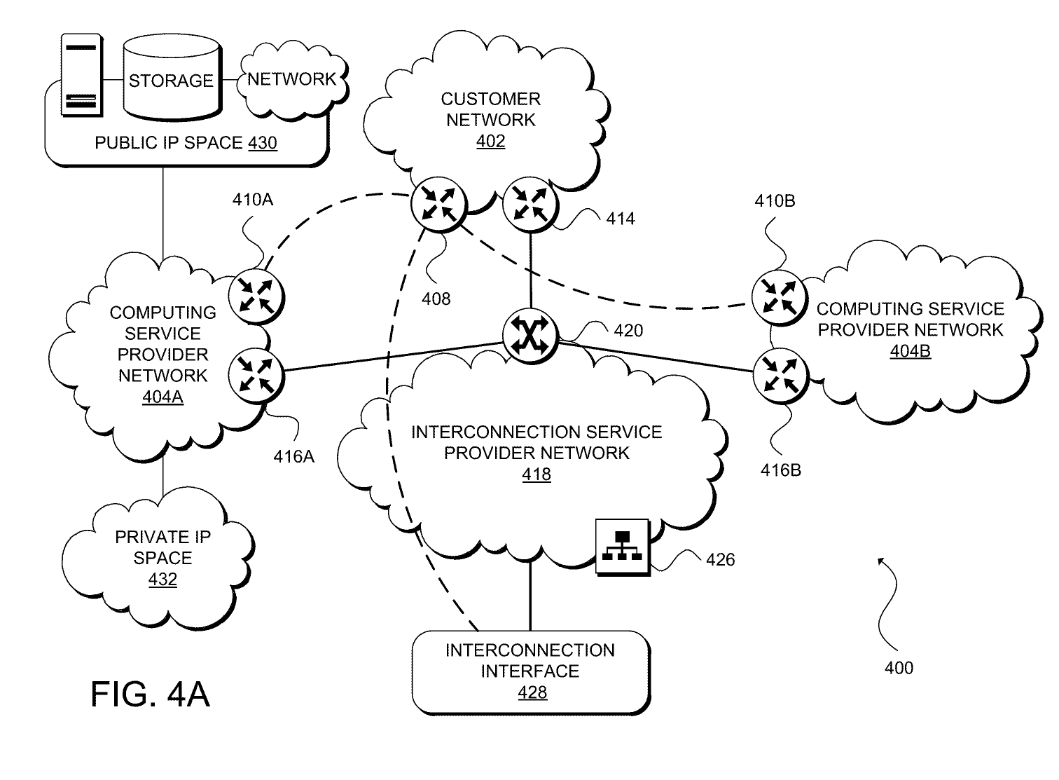

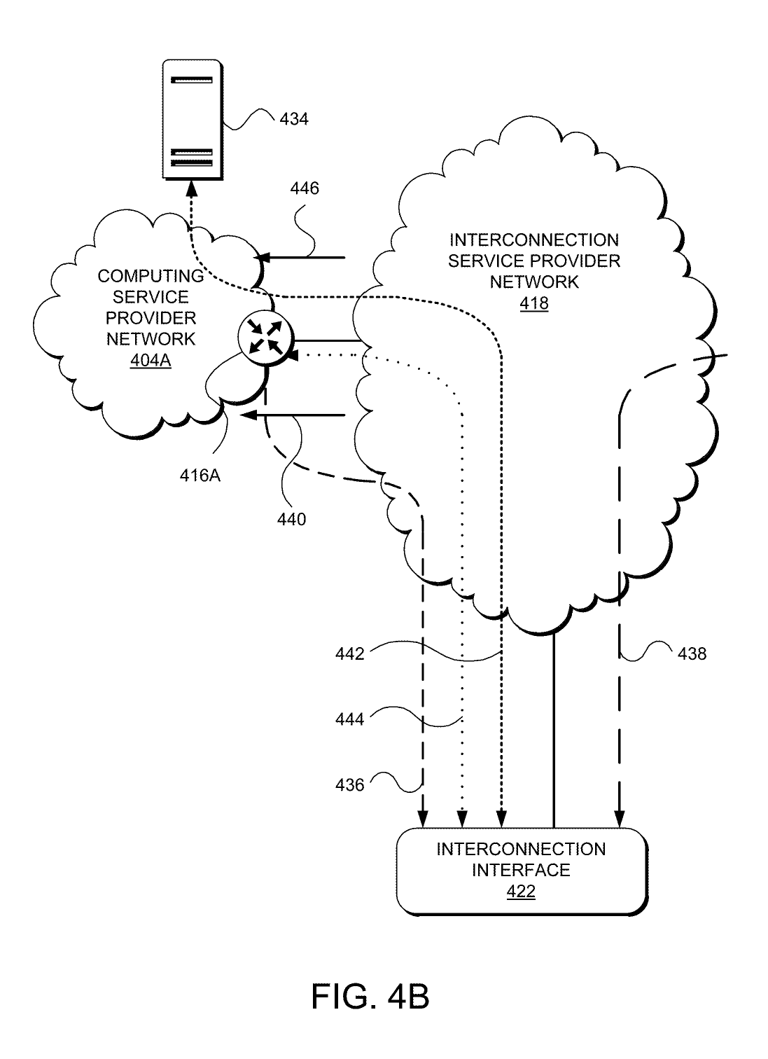

FIG. 4A and FIG. 4B illustrate detailed views of a hybrid cloud computing network 400 for optimizing external network connectivity. Hybrid cloud computing network 400 includes customer network 402, computing service provider networks 404A and 404B (collectively, “404”), and interconnection service provider network 418. Customer network 402 includes edge router 408 that operates as a public interface for connecting to public interfaces of computing service provider networks 404 and interconnection service provider network 418. For example, edge router 408 may connect to an IAP network and/or other networks (not shown) that ultimately connects to edge router 410A of computing service provider network 404A, edge router 410B of computing service provider network 404B, and interconnection interface 428. Customer network 402 also includes edge router 414 that directly connects to edge router 420 of interconnection service provider network 418. Computing service provider networks 404A and 404B also include edge routers 416A and 416B (collectively, “416”), respectively, to connect to edge router 420.

Interconnection service provider network 418 includes software defined network (SDN) controller 426 for configuring, managing, and monitoring any number of network devices, network appliances, and other components of interconnection service provider network 418, including edge router 420 for connecting to edge router 414 of customer network 402, edge router 416A of computing service provider network 404A, and edge router 416B of computing service provider network 404B. SDN controller 426 manages the various resources of interconnection service provider network 418. For example, SDN controller 426 can provision network resources based on customer requests, schedules, triggers, events, signals, messages, alerts, agreements, subscriptions, purchases, or other factors. In addition, SDN controller 426 can handle traffic and manage configuration of the network resources, including managing network routing/re-routing, network data backup, security policies, etc. In some embodiments, SDN controller 426 can collect data from a customer and generate configuration information for specific network deployments. For example, SDN controller 426 can generate security policies, subnetting and routing schemes, forwarding schemes, network address translation (NAT) settings, virtual private network (VPN) settings, etc. SDN controller 426 can push or transmit these data and settings to components of interconnection service provider network 418 to implement a particular network deployment. For example, SDN controller 426 can generate VPN settings, such as IP mappings, port number, and security information, and send the VPN settings to the components of interconnection service provider network 418. A component of interconnection service provider network 418 can use the VPN settings to establish a VPN tunnel according to the settings. As another example, SDN controller 426 may generate and manage network diagnostic tools or graphical user interfaces, or automate the interconnection between multiple networks and resources.

In some embodiments, SDN controller 426 can deploy a network, configure links or devices, or provide other services for customers, such as network administration services, network monitoring services, content filtering services, application control, WAN optimization, firewall services, gateway services, storage services, protocol configuration services, wireless deployment services, interconnection services, network services, etc.

Various nodes and networks in hybrid cloud computing network 400 may exchange packets (e.g., network traffic and/or messages) using various network protocols, including wired protocols, wireless protocols, security protocols, Open Systems Interconnection (OSI)-Layer specific protocols, labels, or other protocols. Other embodiments may use protocols such as Session Initiation Protocol (SIP), protocols from the Internet Protocol (IP) Suite, such as TCP/IP; OSI (Open Systems Interconnection) protocols, such as L1-L7 protocols; routing protocols, such as RIP, BGP, STP, OSPF, EIGRP, Intermediate System to Intermediate System (IS-IS); or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can facilitate communications both within a network and between networks. The various hardware and software components or devices comprise network nodes, such as switches, hubs, routers, access points (APs), antennas, network interface cards (NICs), modules, cables, firewalls, servers, repeaters, sensors, and the like.

In the example of FIG. 4A and FIG. 4B, SDN controller 426 comprises a centralized server or cluster of servers. In other embodiments, SDN controller 426 can comprise a single network device and operate similarly to conventional IP routing devices but with a common interface between the aggregate control plane and data plane of edge router 420. In an embodiment, SDN controller 426 may be implemented using the OpenFlow Switch Specification version 1.3.0 (Jun. 25, 2012) or a later version or derivation thereof. SDN controller 426 may communicate over a secure channel with edge router 420 through the OpenFlow protocol to program flow rules that control the routes of packets through interconnection service provider network 418. The flow rules comprise flow descriptions and actions. The flow descriptions are a 12-tuple of L2-L4 header fields, any of which can be wildcards. Interconnection service provider network 418 can match incoming packets against the flow descriptions, and if there is a match, interconnection service provider network 418 performs the action (e.g., push, pop, or swap) on the packet corresponding to the matching flow description. If a packet matches multiple flow descriptions, interconnection service provider network 418 may apply the flow rule with the highest priority.

Interconnection service provider network 418 also includes interconnection interface 428. Interconnection interface 428 is a component of interconnection service provider network 418 for facilitating migration of data and workloads from computing service provider network 404A to computing service provider network 404B. Interconnection interface 428 can provide a user interface that allows a customer to provide credentials to the customer's resources in customer service provider networks 404. In other embodiments, the customer may be associated with a federated identity that enables access to two or more of customer network 402, computing service provider 204, and interconnection service provider network 418. In some embodiments, the user interface may also enable the customer to identify the specific resources in computing service provider network 404A that the user would like to migrate to computing service provider network 404B. In other embodiments, interconnection service provider network 418 may automatically identify resources provisioned to the customer in computing service provider networks 404, and the user interface enables the user to select the specific resources to migrate from computing service provider network 404A to computing service provider network 404B. In some embodiments, migration may involve transferring data associated with specific resources in computing service provider network 404A to corresponding resources already provisioned to the customer by computing service provider network 404B (e.g., storage resources, databases, applications, etc.). In other embodiments, migration can involve instantiation of the corresponding resources in computing service provider network 404B and transfer of data to the instantiated resources.

In various embodiments, interconnection interface 428 may include a component for presenting performance data associated with the customer's provisioned resources currently operating in computing service provider networks 404 and comparative data (e.g., performance, costs, etc.) relating to how corresponding resources would operate if provisioned in other computing service provider networks. The user interface may also enable the customer to select particular performance test suites for measuring performance of the customer's provisioned resources as discussed elsewhere herein.

Computing service provider network 404A is one possible configuration for a computing service provider network. In this example, computing service provider network 404A is partitioned as two IP spaces, public IP space 430 and private IP space 432. Public IP space 430 enables customers to request and access cloud computing resources provisioned by computing service provider network 404A, such as processing, storage, and network resources as discussed elsewhere herein. Computing service provider network 404A also allows customers to extend their private networks and/or create virtual private networks in private IP space 432. That is, certain resources provided by computing service provider network 404A may be associated with private IP addresses. Computing service provider network 404B is another possible configuration for a computing service provider network. Computing service provider network 404B consists of only a public IP space, and thus, all resources and services provided by computing service provider network 404B are associated with public IP addresses.

FIG. 4B illustrates an example approach for optimizing migration of data and workloads from computing service provider network 404A to computing service provider network 404B. In this example, server 434 is a provisioned resource within private IP address space 432 of computing service provider network 404A. Server 434 can be a physical or bare-metal server, a virtual machine (VM), a container, or other type of cloud resource. Server 434 may connect to storage resources (not shown) provisioned by computing service provider network 404A. Server 434 and the storage resources can represent a workload and data that a customer would like to migrate from computing service provider network 404A to computing service provider network 404B.

The migration process can begin with advertisement of IP address spaces among computing service provider network 404A, interconnection service provider network 418, and computing service provider network 404B. For example, computing service provider network 404A can advertise IP address space 436 (public or private) associated with the customer's provisioned resources in computing service provider network 404A to interconnection interface 422, computing service provider network 404B can advertise IP address space 438 (public) associated with the customer's provisioned resources in computing service provider network 404B to interconnection interface 422, and interconnection service provider network 418 may advertise IP address space 440 (private) associated with customer network 402 to computing service provider network 404A.

Based on IP address space 436, interconnection service provider network 418 can establish one end of tunnel 442 between computing service provider network 404A and interconnection service provider network 418, and more specifically, between edge router 416A and interconnection interface 422. Based on IP address space 440, computing service provider network 404A can establish the other end of tunnel 442. In some embodiments, computing service provider network 404A and interconnection service provider network 418 may establish tunnel 442 using Generic Routing Encapsulation (GRE). GRE provides a simple approach to transport packets of one network protocol over another network protocol via encapsulation. For example, GRE can involve encapsulation of a payload (i.e., an inner packet) for delivery to a destination network inside an outer IP packet. GRE tunnel endpoints send payloads through GRE tunnels by routing encapsulated packets through intervening IP networks. Other IP routers along the way do not parse the payload. Instead, the IP routers only parse the outer IP packet as the routers forward the encapsulated packets to the GRE tunnel endpoint. Upon reaching the tunnel endpoint, encapsulated packets are decapsulated, and the payloads are forwarded to their ultimate destination.

In other embodiments, tunnel 442 can take other forms, such as various types of virtual private network (VPN) or Layer 2 (L2) tunneling protocols like VXLAN, Network Virtualization using Generic Routing Encapsulation (NVGRE), or other suitable overlay network protocol. Some embodiments may utilize an open VPN (e.g., OpenVPN) overlay or an IP Security (IPSec) VPN based L3 network extension. In other embodiments, tunnel 436 may utilize a secure transport layer (i.e., L4) tunnel as a communication link, where the secure transport layer tunnel can provide a link layer (i.e., L2) network extension between interconnection service provider network 418 and computing service provider network 404A. Some embodiments may establish tunnel 436 as a secure transport layer (i.e., L4) using technologies such as Transport Layer Security (TLS), Datagram TLS (DTLS), Secure Socket Layer (SSL), or other suitable L4 protocol, and build a secure L2 switch overlay that interconnects interconnection service provider network 418 and computing service provider network 404A. In other words, tunnel 442 can be a secure transport layer tunnel that provides a link layer network extension between interconnection service provider network 418 and computing service provider network 404A. An L4 secure tunnel may be well-suited for use with corporate firewalls and Network Address Translation (NAT) devices due to the nature of the transport level protocols (e.g., UDP/TCP) and the transport layer ports opened for Hyper Text Transfer Protocol (HTTP)/HTTP Secure (HTTPS) in the firewall. With an L2 network overlay, instances of an application executing within a virtual partition (e.g., VM, container, etc.) can be seamlessly migrated to the overlay network dynamically created in computing service provider network 404A, without any impact to existing corporate infrastructure.

After establishing tunnel 442, interconnection interface 422 can peer with edge router 416A of computing service provider network 404A and with edge router 416B of computing service provider network 404B using Border Gateway Protocol (BGP). BGP is an interdomain routing protocol intended to operate between networks under different administrative control (i.e., autonomous systems (AS's). An AS is a group of IP networks operated by one or more network operators that has a single, clearly defined routing policy. A device that is running BGP is known as a BGP speaker. A pair of BGP speakers may form a neighbor relationship (e.g., edge router 416A and interconnection interface 422 or interconnection interface 422 and edge router 416B) and participate in a peering session (i.e., the speakers are peered). BGP speakers peer with one another using TCP (on port 179) to exchange network reachability information. This information is mainly an indication of the full paths that a route must take in order to reach a given destination.

In the example of FIG. 4B, BGP route information 438 can be exchanged over GRE tunnel 436. To migrate data from computing service provider network 404A to computing service provider network 404B, server 434 can receive IP address space 446 associated with computing service provider network 404B and send the data over GRE tunnel 436. As the IP destination is encapsulated when routed through GRE tunnel 436, computing service provider network 404A is only aware that server 434 is sending the data to interconnection interface 422 over a direct connection and computing service provider network 404A is not aware that server 434 is ultimately sending the data to computing service provider network 404B. When the data arrives at interconnection interface 422, the interconnection interface 422 can use network address translation (NAT) to translate the IP source destination to an IP address routable over the direct connection between interconnection interface 422 and computing service provider network 404B. Data sent by computing service provider network 404B intended for computing service provider network 404A can also use interconnection interface 422 as an intermediary, wherein the source address of such data can be translated to a network address routable over the direct connection between interconnection interface 422 and computing service provider network 404A. Many computing service providers network providers charge significantly lower rates for traffic routed through direct connections than for traffic routed through the Internet. Thus, in some embodiments, migrating data over direct connections can improve network performance as well as reduce networking costs for customers.

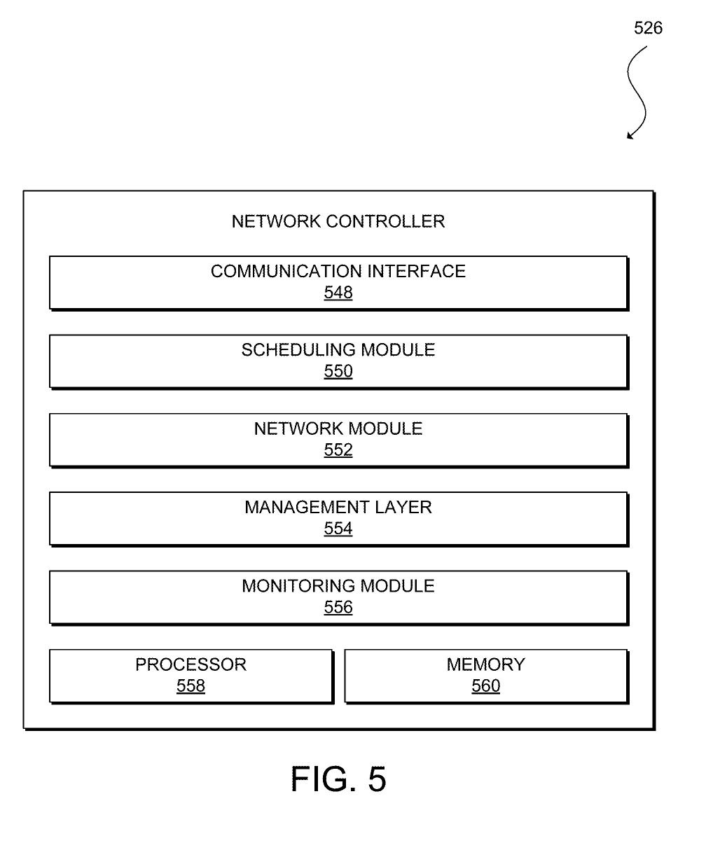

FIG. 5 illustrates an example of SDN controller 526 in accordance with an embodiment. SDN controller 526 can serve as a management system for an interconnection service provider network, such as interconnection service provider network 318 of FIG. 3 or interconnection service provider network 418 of FIG. 4A and FIG. 4B. SDN controller 526 can perform authentication, manage network configuration, provision network resources, and monitor network traffic, among other tasks. For example, SDN controller 526 can manage cloud service provisioning or deployment, such as cloud storage, media, streaming, security, or administration services. SDN controller 526 can also manage VMs, containers, or virtual partitions; networks; service provisioning; virtual circuits between networks or clouds; interfaces; network ports; and so forth.

SDN controller 526 can include several subcomponents, including a communication interface 548, a scheduling module 550, a networking module 552, a management layer 554, a monitoring module 556, one or more processors 558, and memory 460. The various subcomponents can comprise hardware and/or software components (e.g., processor, memory, modules, logic, virtual workload, data structures, etc.). Moreover, although FIG. 5 illustrates one example configuration of the various components of SDN controller 526, those of skill in the art will understand that there are numerous different configurations suitable for various embodiments and other embodiments can include any other type and number of components. For example, networking module 552 and management layer 554 can belong to one software module or multiple separate modules. Other embodiments may combine other modules or further divide certain modules into more subcomponents.

Communications interface 548 allows SDN controller 526 to communicate with other devices or networks, such as customer network 302, computing service provider networks 304, and IAP network 312 of FIG. 3, customer network 402 and computing service provider networks 404 of FIG. 4A and FIG. 4B, or other networks. Communications interface 548 can be a network interface card (NIC), and can include wired and/or wireless capabilities. Communications interface 548 allows SDN controller 526 to send and receive data from other devices and networks. In some embodiments, SDN controller 526 can include multiple communications interfaces for redundancy or failover. For example, SDN controller 526 can include dual NICs for connection redundancy or for multiple lines or channels.

Scheduling module 540 can manage scheduling of procedures, events, services, or communications. For example, scheduling module 550 can schedule when to allocate resources from an interconnection service provider network. As another example, scheduling module 550 can schedule when to transmit specific instructions or commands to network devices (e.g., edge router 320 of FIG. 3 or edge router 420 of FIG. 4A). Scheduling module 550 can provide scheduling for operations performed or executed by the various subcomponents of SDN controller 526. Scheduling module 550 can also schedule resource slots, virtual machines, bandwidth, device activity, status changes, nodes, updates, policies, circuits, services, and the like.

Network module 552 can be a module, application, appliance, logic, processor, or function capable of performing network operations. Network module 552 can thus perform networking calculations, such as network addressing, or networking service or operations, such as auto virtual circuit configuration or traffic routing/re-routing. For example, network module 552 can perform filtering functions, switching functions, failover functions, high availability functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. Network module 552 can handle networking requests from other networks or devices and establish links between devices. Networking module 552 can also perform queueing, messaging, or protocol operations.

Management layer 554 can include logic to perform management operations. For example, management layer 554 can include the logic to allow the various components of SDN controller 526 to interface and work together. Management layer 554 can also include the logic, functions, software, and procedure to allow SDN controller 526 to perform monitoring, management, control, deployment, configuration, and administration operations of other devices, networks, clouds, providers, operations and/or applications, services provided to clients, or any other component or procedure. Management layer 554 can include the logic to operate SDN controller 526 and perform particular services configured on SDN controller 526.

Moreover, management layer 554 can initiate, enable, or launch other instances of SDN controller 526, such as for distributing control of segments of an interconnection service provider network among several SDN controller instances, providing high availability and resilience, and similar situations. In some embodiments, management layer 554 can also provide authentication and security services for an interconnection service provider network, private networks, computing service provider networks, SDN controller 526, and/or any other device or component. Further, management layer 554 can manage nodes, resources, VMs or other virtual partitions, settings, policies, protocols, communications, services, clouds, datacenters, networks, and the like.

Monitoring module 556 can provide an interface or front end where customers, administrators, and other users can access, consume, purchase, configure, remove, manage, and generally monitor cloud and network services. For example, monitoring module 556 can provide a web-based frontend where customers can configure networks that are cloud-managed, provide customer preferences, configure policies, enter data, upload statistics, configure interactions or operations, etc. As another example, monitoring module 556 can provide an interactive display where users can interconnect their network with other networks.

Monitoring module 556 can provide visibility information, such as views of networks or devices, and even provide diagnostic information, e.g., monitoring module 556 can provide a view of the status or conditions of the provider network, the operations taking place, services, performance, a topology or layout, specific network devices, protocols implemented, running processes, errors, notifications, alerts, network structure, ongoing communications, data analysis, etc.

Memory 560 can include any data or information, such as management data, statistics, settings, preferences, profile data, account data, transactions, logs, notifications, attributes, configuration parameters, client information, network information, and the like. For example, SDN controller 526 can collect network statistics from a network device (e.g., edge router 320 of FIG. 3 or edge router 420 of FIG. 4A) and store the statistics in memory 560. Memory 560 can also include performance and/or configuration information. This way, SDN controller 526 can use such data to perform management or service operations for the managed network. Memory 560 can be a physical storage or memory device, a database, a folder, a disk, or any storage medium on SDN controller 526 or accessible to SDN controller 526 (e.g., directly or indirectly).

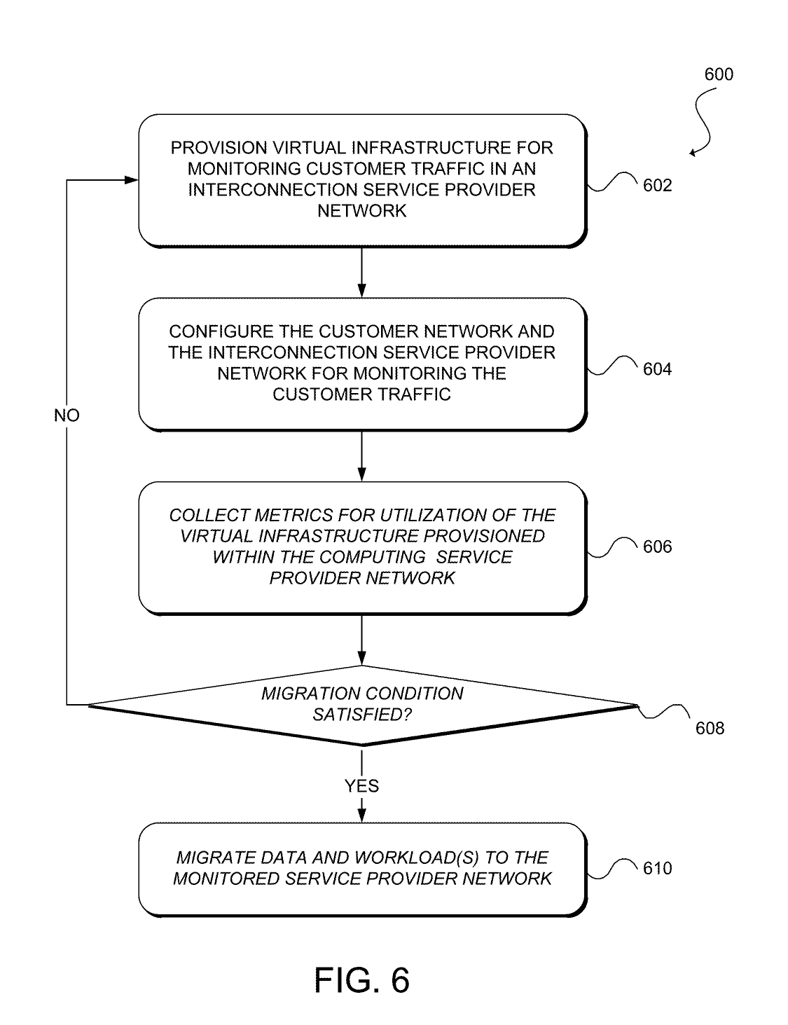

FIG. 6 illustrates an example of a process, method 600, for monitoring a customer's traffic and determining the optimal computing service provider for transporting that traffic. For any method discussed herein, there can be additional, fewer, or alternative steps performed in similar or alternative orders, or in parallel, within the scope of the various embodiments unless otherwise stated. Method 600 may begin with provisioning of the virtual infrastructure for monitoring the customer's traffic at step 602. This can include instantiating, within an interconnection service provider network (e.g., interconnection service provider network 318 of FIG. 3 or interconnection service provider network 418 of FIG. 4A and FIG. 4B), one or more virtual computing instances for processing packets to determine their ultimate destinations, one or more virtual storage instances for storing packet header data and other network-based metrics, and a virtual network fabric for routing the customer's traffic from the customer's private network to the interconnection service provider network and to the traffic's ultimate destination. Depending on the volume of the traffic and sampling strategy (e.g., capturing all traffic or capturing a sampled amount of traffic, such as capturing every 100^{th} packet, 500^{th} packet, 1000^{th} packet, etc.), the instantiation of the virtual infrastructure can also include setting up physical network appliances or virtual network functions for controlling traffic (e.g., load balancers, security appliances, deep packet inspectors for more detailed statistical analysis, etc.).

In some embodiments, the instantiation of the virtual infrastructure for monitoring customer traffic can also include instantiating virtual resources within the computing service provider network for capturing statistical information regarding that provider. For example, some embodiments may also perform comparative analysis between public cloud providers to select the optimal cloud provider on the basis of the customer's specified criteria (e.g., network performance, cost, or a combination thereof). The interconnection service provider may request that the computing service provider network provision certain resources and configure the resources depending on the nature of the performance testing.

Computing service provider network resources and configuration options for such resources generally include any type of computing resource, such as processing, storage, and networking resources. For instance, processing resources and configuration options for processing resources may include a number of virtual central processing units (vCPUs) or graphics processing units (GPUs), processing speed of the vCPU/GPUs, amount(s) of main memory, server type (e.g., bare-metal server, VM, container, etc.), operating system (e.g., UNIX, Linux, Windows, etc.), hypervisor or virtualization platform (e.g., Hyper-V, KVM, VMWare, etc.), or application software. Storage resources and configuration options for storage resources may include hardware type (e.g., hard disk, solid state device (SSD), tape, etc.), storage type (e.g., file system, block storage, etc.), and amount(s) of storage. As discussed, provisioned resources that may also be analyzed include combined computing, storage, and network resources, such as a content delivery network (CDN), database, virtual private network (VPN), domain name system (DNS), identification and authentication (e.g., Active Directory from Microsoft, key management), analytics, message queue, workflow, media, payment, email, Simple Notification Service (SNS), search, source control, monitoring services, or other services. In some embodiments, step 602 can also include provisioning virtual resources in different regions or zones to evaluate network performance between different regions or zones of a same cloud or different clouds.

Method 600 can continue to step 604 with configuring the customer network and provisioned computing resources for capturing traffic and other data relevant to selecting the optimal computing service provider network for a particular customer network. Step 604 can include configuring the customer network to route external traffic out of the customer network to the interconnection service provider network. In some embodiments, step 604 can also include configuring the interconnection service provider network to route the customer's traffic through a service chain for analyzing the traffic. In addition, step 604 can further involve configuring the interconnection service provider network to forward the customer's traffic to provisioned resources in one or more computing service provider networks in order to evaluate performance and other statistical information within those networks. Finally, step 604 includes routing the customer's traffic to its final destination (whether from within the interconnection service provider network or from a computing service provider network).

The measurements analyzed at the interconnection service provider network and/or computing service provider networks can include network bandwidth, throughput, latency, jitter, error rate, among other network connectivity metrics. Other analyses can include the percentages of traffic destined for various IP network prefixes, BGP ASN's, or TCP/IP port numbers (e.g., port 443 for HTTPS or 80 for HTTP). In some embodiments, the measurements can be based on performance testing benchmarks, such as processing performance testing software provided by the Standard Performance Evaluation Corporation (SPEC) of Gainesville, Va. or the Transaction Processing Performance Council (TPC) of San Francisco, Calif.; storage performance testing benchmarks provided by the Storage Performance Council (SPC) of Redwood City, Calif. or the Storage Networking Industry Association (SNIA) of Colorado Springs, Colo.; and network performance testing benchmarks provided by the Internet Engineering Task Force (IETF) of Fremont, Calif. or the International Telecommunication Union (ITU) of Geneva, Switzerland. Other embodiments may utilize custom performance test suites known to those of ordinary skill in the art.

At step 606, the provisioned resources within the interconnection service provider network and/or the computing service provider network(s) may capture metrics relating to the nature of the customer's traffic, network performance, and other performance data. (e.g., processing performance or storage performance) for one or more computing service provider networks). The provisioned resources can collect and aggregate the performance data from the resources provisioned by the interconnection service provider network and/or the computing service provider network(s). For example, the performance monitoring process can generate reports for administrators to facilitate selection of a computing service provider network that may be most suitable for handling a particular migrated workload or use case (e.g., back-up or disaster recovery).

At step 608, the performance data can be analyzed to determine whether a migration condition has been satisfied, such as a determination that it would be advantageous to transfer workloads and/or data from a first computing service provider network to a second computing service provider network. As will be appreciated, the migration condition may depend on numerous factors, such as performance testing results, prices/rates, error rates, security preferences, feature preferences, etc. for a computing service provider network's resources or services. The performance monitoring process disclosed herein can enable all of these various factors to be considered from a single management interface for multiple computing service provider networks.

In some embodiments, the interconnection service provider network can automatically select a particular computing service provider network. The interconnection service provider network can periodically conduct performance testing among several computing service provider networks to determine the provider having the highest performance (e.g., shortest response time, lowest latency, highest throughput, highest bandwidth, etc.), lowest cost, lowest environmental impact, or some combination thereof, and select a new provider network to handle the traffic based on the performance data.

Method 600 can conclude at step 610 with migration of data and workloads from the computing service provider network currently hosting the data and workloads to the monitored computing service provider network. In some embodiments, process 600 can run at certain intervals of time each hour, day, week, year, or other suitable unit of time. For example, an application running in a first computing service provider network and its data may be migrated to a second computing service provider network when the performance data indicates that it may be preferable to run the application in the second computing service provider network instead of the first computing service provider network. Thus, service provider selection can be based on real-time performance. In other embodiments, performance data captured over the course of several intervals can be averaged or weight-averaged (e.g., placing greater weight on more recent performance data).

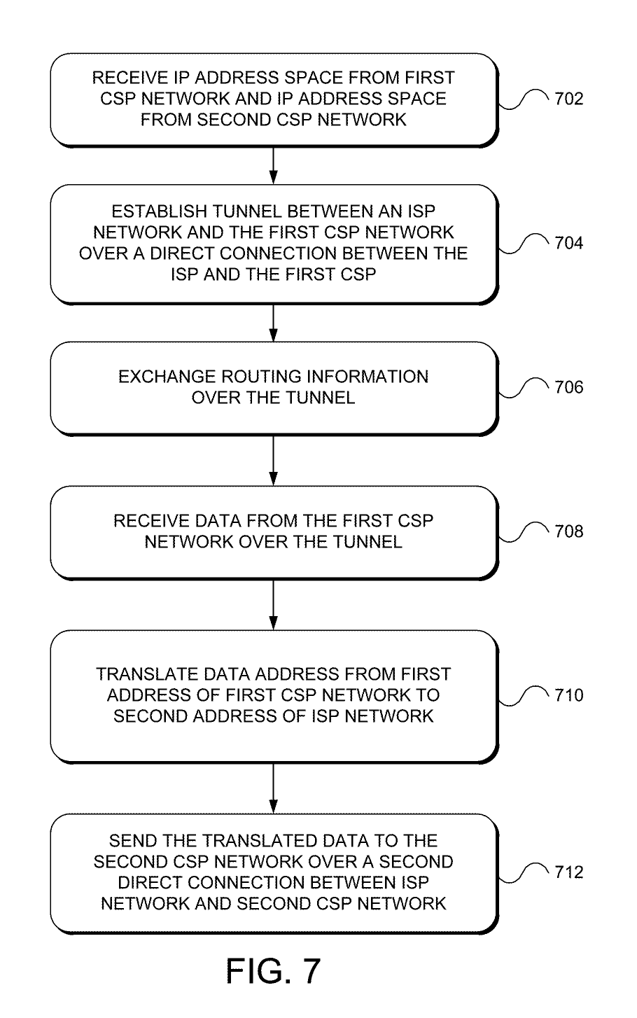

FIG. 7 illustrates an example method 700 for interconnecting multiple computing service provider networks in accordance with an embodiment. Method 700 can be performed by a interconnection service provider network (e.g., interconnection service provider network 318 of FIG. 3 or interconnection service provider network 418 of FIG. 4A and FIG. 4B), an interconnection interface (e.g., interconnection interface 422 of FIG. 4A and FIG. 4B), or other suitable entity. Method 700 may begin at step 702 with an interconnection service provider network receiving an IP address space advertisement from a first computing service provider network and IP address space advertisement from a second computing service provider network. In some embodiments, the interconnection service provider network may also send its IP address space advertisement to the first computing service provider network and/or the second computing service provider network. In some embodiments, this IP address space may be associated with a private cloud of a customer of the interconnection service provider network. For example, the customer may utilize the interconnection service provider network as an extension of the customer's private cloud and may request the interconnection service provider network to migrate the customer's resources provisioned in the first computing service provider network to the second computing service provider network.

Method 700 can continue at step 704 with establishing a tunnel between the interconnection service provider network and the first computing service provider network using the IP address spaces exchanged between these networks. In some embodiments, the tunnel may be implemented using GRE. In other embodiments, the tunnel may be implemented using other tunneling technologies, such as VXLAN or NVGRE; virtual private network technologies, such as OpenVPN or IPSec; secure transport layer or L4 technologies, such as TLS, DTLS, or SSL.

At step 706, the interconnection service provider network can exchange routing information with the first computing service provider network and the second computing service provider network. In some embodiments, BGP may be used as the routing protocol and BGP routing information can be exchanged over a GRE tunnel or other suitable tunnel. This can involve a BGP device within the interconnection service provider network peering with a BGP device in the first computing service provider network and the same BGP device or a different BGP device within the interconnection service provider network peering with a BGP device in the second computing service provider network.

Method 700 may proceed to step 708 in which the first computing service provider network can migrate its workloads and/or data to the second computing service provider network. As discussed, this can involve the first computing service provider network receiving an IP address space advertisement from the second computing service provider network, which the first computing service provider network can utilize to generate IP packets destined for the second computing service provider network. The first computing service provider network can send the IP packets over the GRE tunnel, which can involve encapsulation of the IP packets to a destination corresponding to the interconnection service provider network. Upon arrival to the interconnection service provider network, the encapsulated IP packets can be decapsulated (e.g., removal of GRE header and outer IP header).

At step 710, the interconnection service provider network can translate the source address of the decapsulated IP packets to an address routable to the second computing service provider network over a second direct connection between the interconnection service provider network and the second computing service provider network. For example, certain computing service provider network providers may assign specific network address to use for routing packets through a direct connection, and a NAT module of the interconnection service provider network can translate the source address of the decapsulated IP packets to this specific network address. As discussed, this gives the appearance that the traffic originates from the specific network address instead of the first computing service provider network. Method 700 may conclude at step 712 in which interconnection service provider network forwards the IP packets with the translated source addresses to the second computing service provider network.

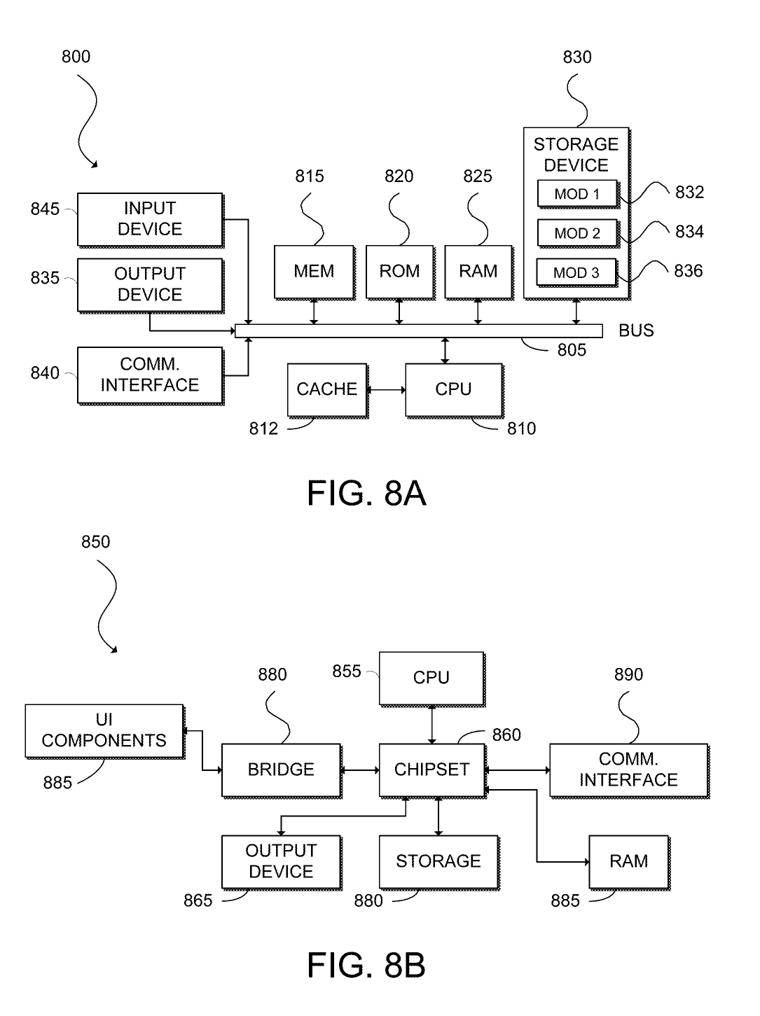

FIG. 8A and FIG. 8B illustrate systems in accordance with various embodiments. The more appropriate system will be apparent to those of ordinary skill in the art when practicing the various embodiments. Persons of ordinary skill in the art will also readily appreciate that other systems are possible.

FIG. 8A illustrates an example architecture for bus computing system 800, wherein the components of system 800 are in electrical communication with each other using bus 805. Computing system 800 can include processing unit (CPU or processor) 810 and system bus 805 that may couple various system components including system memory 815, such as read only memory (ROM) in storage device 830 and random access memory (RAM) 825, to processor 810. Computing system 800 can include cache 812 of high-speed memory connected directly with, in close proximity to, or integrated as part of processor 810. Computing system 800 can copy data from memory 815 and/or storage device 830 to cache 812 for quick access by processor 810. In this manner, cache 812 can provide a performance boost that avoids processor delays while waiting for data. These and other modules can control processor 810 to perform various actions. Other system memory may be available for use as well. Memory 815 can include multiple different types of memory with different performance characteristics. Processor 810 can include any general purpose processor and a hardware module or software module, such as module 832, module 834, and module 836 stored in storage device 830, configured to control processor 810 or a special-purpose processor that incorporates software instructions into the actual processor design. Processor 810 may essentially be a completely self-contained computing system, containing multiple cores or processors, a bus, memory controller, cache, etc. A multi-core processor may be symmetric or asymmetric.

To enable user interaction with computing system 800, input device 845 can represent any number of input mechanisms, such as a microphone for speech, a touch-protected screen for gesture or graphical input, keyboard, mouse, motion input and so forth. Output device 835 can also be one or more of a number of output mechanisms known to those of skill in the art. In some instances, multimodal systems can enable a user to provide multiple types of input to communicate with computing system 800. Communications interface 840 can govern and manage the user input and system output. There may be no restriction on operating on any particular hardware arrangement and therefore the basic features here may utilize improved hardware or firmware arrangements as they are developed.

Storage device 830 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and hybrids thereof.

FIG. 8B illustrates an example architecture for a conventional chipset computing system 850 in accordance with an embodiment. Computing system 850 can include processor 855, representative of any number of physically and/or logically distinct resources capable of executing software, firmware, and hardware. Processor 855 can communicate with chipset 860 to control input to and output from processor 855. In this example, chipset 860 can output information to output device 865, such as a display, and can read and write information to storage device 870, which can include magnetic media, and solid state media, for example. Chipset 860 can also read data from and write data to RAM 875. Bridge 880 for interfacing with a variety of user interface components 885 can also interface with chipset 860. User interface components 885 can include a keyboard, a microphone, touch detection and processing circuitry, a pointing device, such as a mouse, and so on. Inputs to computing system 850 can come from any of a variety of sources, machine generated and/or human generated.

Chipset 860 can also interface with one or more communication interfaces 890 that can have different physical interfaces. Communication interfaces 890 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage device 870 or RAM 875. Further, computing system 850 can receive inputs from a user via user interface components 885 and execute appropriate functions, such as browsing functions by interpreting these inputs using processor 855.

In some embodiments, computing systems 800 and 850 can have more than one processor, or be part of a group or cluster of computing devices networked together to provide greater processing capability.

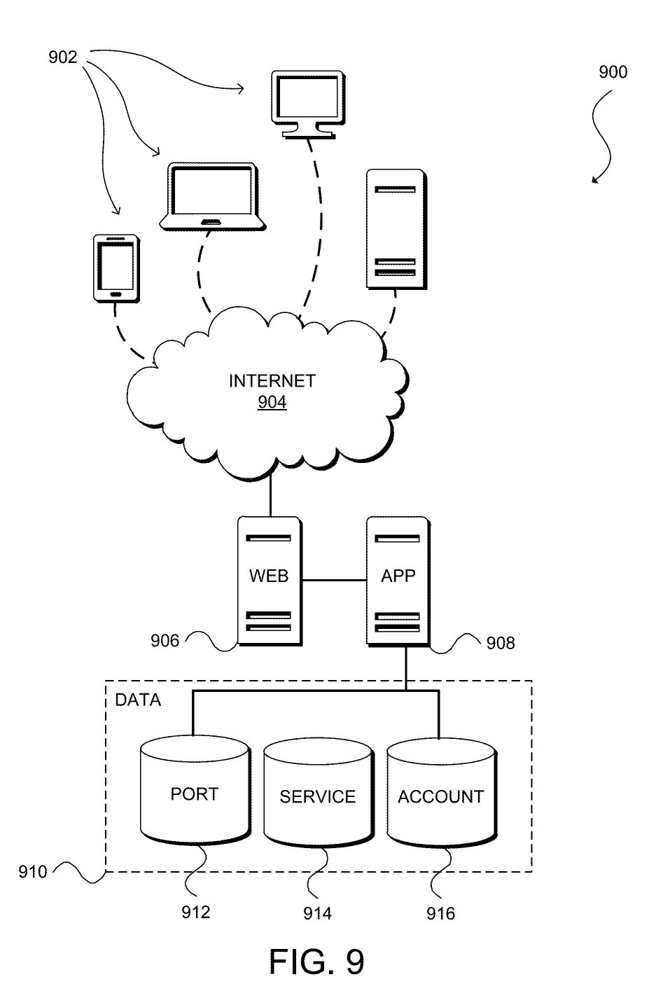

FIG. 9 illustrates an example of computing environment 900 for implementing certain aspects of the present technology in accordance with an embodiment. For instance, interconnection interface 322 of FIGS. 3A and 3B may include a graphical user interface implemented according to computing environment 900. Although this example uses a WAN-based environment for purposes of explanation, other embodiments may implement different environments as known to those of ordinary skill in the art. Computing environment 900 includes client devices 902, which can comprise any appropriate electronic device capable of sending and receiving requests, messages, or information over WAN 904 and conveying information back to a user (or other entity) of associated with the device. Examples of client devices 902 include desktop computers, laptops, tablets, smart phones, wearable devices, and the like. WAN 904 can include any appropriate network, including an intranet, the Internet, a cellular network, a local area network, or any other such network or combination thereof. Components used for such a system can depend at least in part on the type of network and/or environment selected. Communication over WAN 904 can occur over wired or wireless connections and combinations thereof. In this example, WAN 904 includes the Internet, as computing environment 900 includes web server 906 for receiving requests and responding to the requests by serving content, although other embodiments may use an alternative device serving a similar purpose as would be apparent to one of ordinary skill in the art.

Computing environment 900 also includes application server 908 and data layer 910. One skilled in the art can appreciate that there can be several web, application, and data servers, layers, or other elements, processes or components, which may be chained or otherwise configured, to handle requests and providing responses. Data layer 910 may include any device or combination of devices capable of storing, accessing, and retrieving data, such as any combination and number of data servers, databases, data storage devices, and data storage media, in any standard, distributed, or clustered environment. Application server 908 can include any appropriate hardware and software for integrating with data layer 910 as necessary to execute aspects of one or more applications for client devices 902 and handling a majority of the data access and business logic for an application. Application server 908 provides access control services in cooperation with data layer 910, and application server 908 may generate content such as text, graphics, audio, and/or video for presentation to the user. Web server 906 may serve the content to the user in the form of Hypertext Mark-up Language (HTML), Extensible Mark-up Language (XML), or other suitable implementation, such as a Restful State Transfer (REST) architecture with JavaScript Object Notation (JSON). Web server 906 may also handle all client requests and responses and the delivery of content between client devices 902 and application server 908.

Data layer 910 can include several separate data tables, databases, or other data storage mechanisms and media for storing data. For example, data layer 910 includes mechanisms for storing data for ports or interfaces 912 provisioned to customers, data for network services 914 provisioned to customers, and customer account data 916. A skilled artisan will appreciate that there can be other subject matter requiring storage in data layer 910, such as account information and performance data. The above listed mechanisms may store some of this data, or additional mechanisms in data layer 910 may store this information. Data layer 910 is operable, through associated logic, to receive instructions from application server 908 and obtain, update, or otherwise process data. In an embodiment, a user may request for a private interconnection between multiple computing service provider networks via a GUI served by web server 906. In this case, web server 906 may send an appropriate request to application server 908. Application server 908 may access account data 916 of data layer 910 to acquire customer account information to verify the identity of the user. Applicant server 908 may also access port data 912 and service data 914 to provision the interconnection service requested by the user. Web server 906 may serve information relating to results of the provisioned service to the user, such as in a results listing on a webpage that the user can view via a browser on client device 902.

Each server 906 and 908 can include an operating system that provides executable program instructions for the general administration and operation of that server. Each server can also include computer-readable medium storing instructions that, when executed by a processor of the server, allow the server to perform its intended functions. Suitable implementations for the operating system and general functionality of the servers are known or commercially available for implementation by persons having ordinary skill in the art.

In some embodiments, computing environment 900 is a distributed computing environment utilizing several computer systems and components interconnected via communication links, using one or more computer networks or direct connections. However, one of ordinary skill in the art will appreciate that such a system could operate equally well in a system having fewer or a greater number of components than illustrated in FIG. 9. Thus, the depiction of computing environment 900 in FIG. 9 is illustrative in nature and not intended to the scope of the disclosure.

Some embodiments utilize at least one network that would be familiar to those skilled in the art for supporting communications using commercially-available protocols, such as TCP/IP, OSI, FTP, UPnP, NFS, CIFS, and AppleTalk. The network can be a LAN, WAN, VPN, the Internet, an intranet, an extranet, a public switched telephone network, an infrared network, a wireless network, and any combination thereof.

In embodiments utilizing a web server, the web server can run any of a variety of server or mid-tier applications, including HTTP servers, FTP servers, CGI servers, data servers, Java servers, and business application servers. The server(s) may also be capable of executing programs or scripts in response to requests from client devices, such as by executing one or more web applications implemented as one or more scripts or programs written in any programming language, such as Java, C, C#, or C++ or any scripting language, such as Perl, Python, or TCL, as well as combinations thereof. The server(s) may also include database servers, including without limitation those commercially available from Oracle, Microsoft, Sybase, and/or IBM, etc.

For clarity of explanation, in some instances, the various embodiments may be presented as including individual functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described embodiments can use computer-executable instructions stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media can store instructions, information used, and/or information created during methods according to described embodiments, and can include magnetic or optical disks, flash memory, USB devices provided with non-volatile memory, networked storage devices, and so on.

Devices implementing methods according to various embodiments can comprise hardware, firmware, and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
receiving, by an interconnection service provider network, first network address information from a first computing service provider network and second network address information from a second computing service provider network;
establishing a tunnel between the interconnection service provider network and the first computing service provider network over a first direct connection between the interconnection service provider network and the first computing service provider network;
exchanging routing information over the tunnel;
receiving, by the interconnection service provider network, data from the first computing service network over the tunnel, the data including first source network address information associated with the first computing service provider network;
generating updated data by translating the first source network address information to second source network address information associated with the interconnection service provider network; and
sending the updated data to the second computing service provider network over a second direct connection between the interconnection service provider network and the second computing service provider network.

2. The computer-implemented method of claim 1, further comprising:
instantiating, by the interconnection service provider network, one or more virtual resources within the interconnection service provider network for analyzing traffic;
configuring a customer network to route external traffic exiting the customer network to the interconnection service provider network;
receiving, by the interconnection service provider network, the external traffic from the customer network; and
analyzing, by the interconnection service provider network, the external traffic to determine that a final destination for a percentage of the external traffic exceeds a specified threshold.

3. The computer-implemented method of claim 2, further comprising:
establishing, by the interconnection service provider network, a direct connection between the customer network and the final destination.

4. The computer-implemented method of claim 3, wherein the final destination comprises at least one of a set of common IP network prefixes, a set of common Border Gateway Protocol (BGP) Autonomous System Numbers (ASNs), or a common set of TCP/IP port numbers.

5. The computer-implemented method of claim 2, further comprising:
configuring the interconnection service provider network to route the external traffic to the final destination.

6. The computer-implemented method of claim 2, further comprising:
configuring the interconnection service provider network to route the external traffic through a service chain for collecting information for the external traffic.

7. The computer-implemented method of claim 1, further comprising:
receiving, by the interconnection service provider network, first performance information from a first computing service provider network and second performance information from a second computing service provider network; and
determining that a migration condition for migrating the data from the first computing service provider network to the second computing service provider network has been satisfied based at least in part on the first performance information and the second performance information.

8. A computer-implemented method, comprising:
instantiating, by an interconnection service provider network, one or more virtual resources within the interconnection service provider network for analyzing traffic;
configuring a customer network to route external traffic exiting the customer network to the interconnection service provider network;
receiving, by the interconnection service provider network, the external traffic from the customer network;
analyzing, by the interconnection service provider network, the external traffic to determine that a final destination for a percentage of the external traffic exceeds a specified threshold; and
establishing, by the interconnection service provider network, a direct connection between the customer network and the final destination.

9. The computer-implemented method of claim 8, wherein the final destination comprises at least one of a set of common IP network prefixes, a set of common Border Gateway Protocol (BGP) Autonomous System Numbers (ASNs), or a common set of TCP/IP port numbers.

10. The computer-implemented method of claim 8, further comprising:
configuring the interconnection service provider network to route the external traffic to the final destination.

11. The computer-implemented method of claim 8, further comprising:
configuring the interconnection service provider network to route the external traffic through a service chain for collecting information for the external traffic.

12. The computer-implemented method of claim 8, further comprising:
receiving, by the interconnection service provider network, first network address information from a first computing service provider network and second network address information from a second computing service provider network;
establishing a tunnel between the interconnection service provider network and the first computing service provider network over a first direct connection between the interconnection service provider network and the first computing service provider network;
exchanging routing information over the tunnel;
receiving, by the interconnection service provider network, data from the first computing service network over the tunnel, the data including first source network address information associated with the first computing service provider network;
generating updated data by translating the first source network address information to second source network address information associated with the interconnection service provider network; and
sending the updated data to the second computing service provider network over a second direct connection between the interconnection service provider network and the second computing service provider network.

13. The computer-implemented method of claim 12, further comprising:
receiving, by the interconnection service provider network, first performance information from a first computing service provider network and second performance information from a second computing service provider network; and
determining that a migration condition for migrating the data from the first computing service provider network to the second computing service provider network has been satisfied based at least in part on the first performance information and the second performance information.

14. A computing system, comprising:
a processor; and
memory including instructions that upon execution by the processor cause the computing system to:
instantiate, by an interconnection service provider network, one or more virtual resources within the interconnection service provider network for analyzing traffic;
configure a customer network to route external traffic exiting the customer network to the interconnection service provider network;
receive, by the interconnection service provider network, the external traffic from the customer network;
analyze, by the interconnection service provider network, the external traffic to determine that a final destination for a percentage of the external traffic exceeds a specified threshold; and
establish, by the interconnection service provider network, a direct connection between the customer network and the final destination.

15. The computing system of claim 14, wherein the final destination comprises at least one of a set of common IP network prefixes, a set of common Border Gateway Protocol (BGP) Autonomous System Numbers (ASNs), or a common set of TCP/IP port numbers.

16. The computing system of claim 14, wherein the instructions upon execution further cause the computing system to:
configure the interconnection service provider network to route the external traffic to the final destination.

17. The computing system of claim 14, wherein the instructions upon execution further cause the computing system to:
configuring the interconnection service provider network to route the external traffic through a service chain for collecting information for the external traffic.

18. The computing system of claim 14, wherein the instructions upon execution further cause the computing system to:
receive, by the interconnection service provider network, first network address information from a first computing service provider network and second network address information from a second computing service provider network;
establish a tunnel between the interconnection service provider network and the first computing service provider network over a first direct connection between the interconnection service provider network and the first computing service provider network;
exchange routing information over the tunnel;
receive, by the interconnection service provider network, data from the first computing service network over the tunnel, the data including first source network address information associated with the first computing service provider network;
generate updated data by translating the first source network address information to second source network address information associated with the interconnection service provider network; and
send the updated data to the second computing service provider network over a second direct connection between the interconnection service provider network and the second computing service provider network.

19. The computing system of claim 18, wherein the instructions upon execution further cause the computing system to:
receive, by the interconnection service provider network, first performance information from a first computing service provider network and second performance information from a second computing service provider network; and
determine that a migration condition for migrating the data from the first computing service provider network to the second computing service provider network has been satisfied based at least in part on the first performance information and the second performance information.

20. The computing system of claim 18, wherein the instructions upon execution further cause the computing system to:
schedule performance testing of the first computing service provider network and the second computing service provider network at a specified interval.
